(19) United States
(12) Patent Application Publication
(10) Pub. No.: US 2006/0261520 A1
(43) Pub. Date: Nov. 23, 2006

(54) Process for producing a plastic part, tool for executing the process and plastic part produced according to said process

(75) Inventors: Michael Ilg, Gomadingen (DE); Erich Amann, Rottenburg (DE); Klaus Bendl, Oberderdingen (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: ElringKlinger AG

(21) Appl. No.: 11/429,284

(22) Filed: May 8, 2006

(30) Foreign Application Priority Data
May 19, 2005 (DE) 10 2005 022 956.5

(51) Int. Cl. B29C 45/00

(52) U.S. Cl. 264/328.1; 264/334

(57) ABSTRACT

The invention relates to a process for producing a plastic part (10), especially in the form of a control valve housing part for a transmission in motor vehicles, with a plurality of fluid-carrying channels (12) which are bordered at least partially by side walls (14), of which some arranged next to one another border on an installation space (20) for holding at least one installation part which is prepared by means of one mold part (26) as part of the molding tool (18), a tool suitable for this purpose and a mold part produced according to this process.

The invention relates to a process for producing a plastic part, a tool for executing the process and a plastic part produced according to said process.

DE 102 60 042 A1 discloses providing a turbocharger housing of an exhaust turbocharger of an internal combustion engine with a compressor housing which is made of duroplastic and which comprises a compressor rear wall and a compressor front part connected to the latter with the formation of a compressor interior, with a helical inside contour.

In the past such a housing of an exhaust turbocharger, especially for a motor vehicle, had been produced from a metallic material. Furthermore it is possible to save weight by using ceramic materials or carbon composites. Production of such a turbocharger housing however dictates complex production processes that involve considerable cost. In the known arrangement according to DE 102 60 042 A1 the compressor housing parts produced by means of a duroplastic comprise parts of the turbocharger, especially in the form of its compressor part; receiving the components in an integrating manner into the plastic walls of the housing part alone is not provided and is not possible with the described arrangement either.

Proceeding from this prior art, the object of the invention is to further improve the known solutions while maintaining the described advantages in the prior art such that possible applications for plastic parts, preferably within automotive technology, can be increasingly opened up.

The process as claimed in the invention is characterized in that a plastic part, especially in the form of a control valve housing part for a transmission in motor vehicles, with a plurality of fluid-carrying channels, is bordered at least partially by side walls, of which some arranged next to one another border on an installation space for holding at least one control part which is prepared by means of one mold part of the molding tool. In this way the process as claimed in the invention can be applied to applications in which an installation space can be formed in the plastic parts themselves for holding the installed part. It is surprising to one with average skill in the art in the area of plastics technology in motor vehicles that by applying the process as claimed in the invention one can use plastics, especially in the area of motor vehicle drives which for a long time were acknowledged as not accessible to this area.

Thus, in the past control valve housing parts for manual or automatic transmissions in motor vehicles were made from diecast aluminum. These transmissions have a plurality of fluid-carrying channels with bordering side walls being at least partially machined in order in this way to create installation space for holding installation parts such as control valves for fluid routing and triggering. Because according to the process as claimed in the invention the installation space for the control valve is prepared separately from it, cutting processes can be abandoned and the installation space is obtained directly by way of the plastic shaping process.

In one preferred embodiment of the process as claimed in the invention, it is provided that the molding tool is provided with guide gates which at least partially border the side walls of the installation space and are placed in through openings which are used for passage of the mold part, and which have a free cross section which is chosen to be larger than the free cross section of the installation space. Preferably it is furthermore provided that when the mold part is placed in the through openings of the molding tool the plastic material is supplied to the molding tool and fills the space between the slide part and the assignable through opening with the formation of wall parts and that after removal of the mold part and ejection of the plastic part from the molding tool the latter breaks out the wall parts with clearance of the installation space.

In this way very good removal of the plastic mold part from the mold is achieved and in this way an accessible installation space for insertion of installation parts such as control valves is formed without major reworking. In particular the use of repeated metalworking can be abandoned and the outline of the installation space can be obtained with an exact size economically by means of brushing or blowing processes, as are conventional in molding of plastic.

In one espeoially preferred embodiment of the process as claimed in the invention, it is provided that the mold material of the plastic part is a duroplastic, preferably in the form of a phenolic resin which is placed in the molding tool by means of a conventional injection or diecasting process. By using a duroplastic in the form of a phenolic resin a very compressively strong execution for the plastic part can be achieved and temperature stability over the indicated temperature range prevails. In particular, it has been found to be advantageous for the phenolic resin to have a uniform elastic modulus over the entire working temperature range of the control valve housing part. The resulting phenolic resin motor vehicle control valve housing part can accordingly be regarded as especially well suited to the stresses that arise and is also very light; all of which contributes to a saving in the weight of the transmission. Since complex reworking processes, such as metalworking or the like, can be abandoned, moreover the described production process is very economical to use.

Other advantageous embodiments of the solution as claimed in the invention which relate to the molding tool and the plastic part itself are the subject matter of the other dependent claims.

The solution as claimed in the invention is detailed below using one embodiment as shown in the drawings. The figures are schematic and are not drawn to scale.

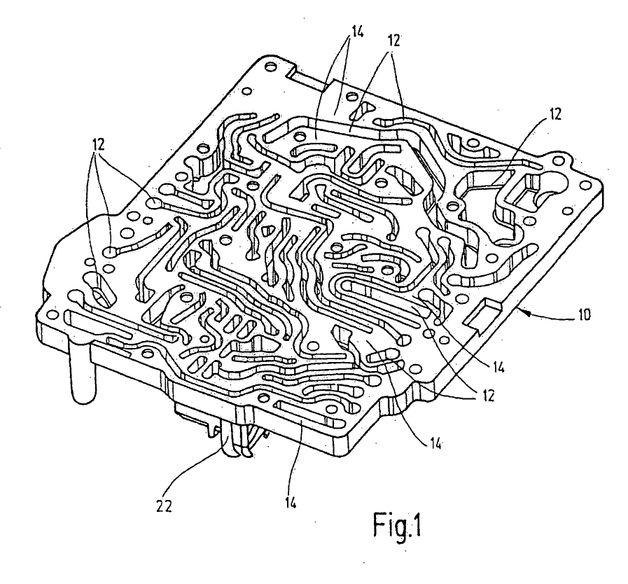

FIG. 1 shows in a perspective top view the oil channel side of a control valve housing part for a transmission in a motor vehicle;

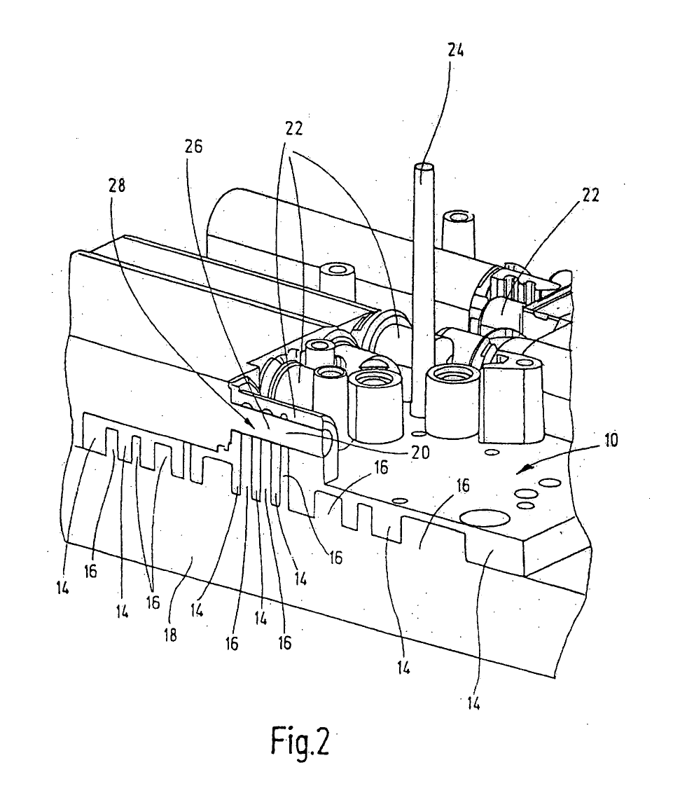

FIG. 2 shows in a perspective top view one part of the molding tool with the plastic material added;

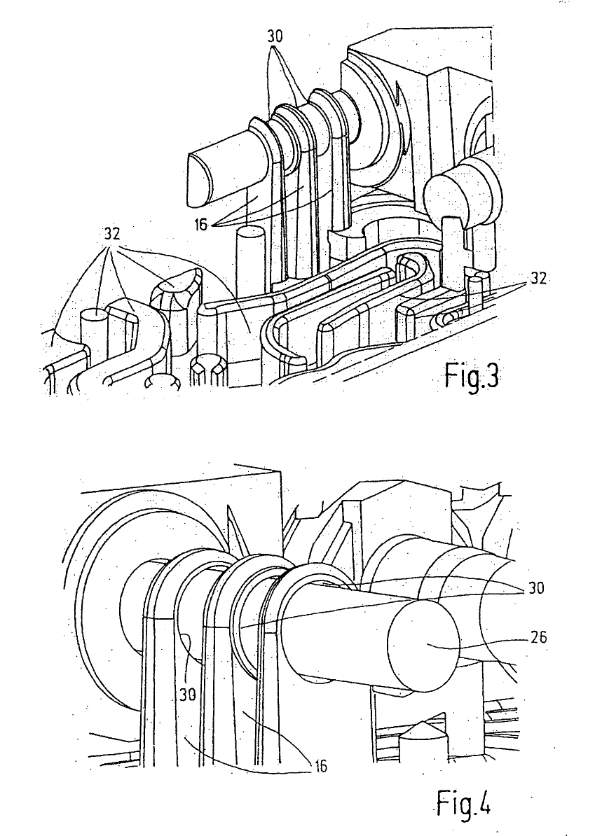

FIGS. 3 and 4 show in different views parts of the molding tool used for the production process in addition to the mold part.

FIG. 1 shows a plastic part labelled 10 altogether in the form of a control valve housing part, as is used in motor vehicle transmissions, for example in the form of manual or automatic transmissions, optionally together with other control valve housing parts which are not detailed. The plastic part 10 shown in FIG. 1 in the form of a control valve housing part has a plurality of fluid-carrying channels 12 which are bordered accordingly by side walls 14. In FIG. 2 some of the side walls 14 are shown in a section and the cavities between the side walls 14 in a successive arrangement, subsequently after shaping, form a part of the fluid carrying channels 12 and are bordered as shown in FIG. 2 by guide gates 16 which are part of a molding tool 18, of which in FIG. 2 only the lower part is shown, conversely for the sake of simpler representation the top molding tool half for closing and opening the entire mold not being detailed.

To limit the installation space 20 to the outside the plastic material should encompass it in the radial peripheral direction, and then in this way it forms essentially cylindrical housing parts 22 for holding the installation parts, for example in the form of control valves which are not shown for the control valve housing part 10. In this respect the top of the control valve housing part facing the viewer as shown in FIG. 1 is located lying on the bottom in FIG. 2 and the bottom of the control valve housing part as shown in FIG. 1 with its projecting housing parts 22 forms the top as shown in FIG. 2. Furthermore, FIG. 2 shows a feed channel 24 filled with plastic material which is used to supply plastic material to the mold, as already shown, in FIG. 2 only the bottom part of the molding tool 18 being shown and not the pertinent tool top part which borders the mold toward the top as is molds.

As FIG. 2 furthermore shows, in the direction of looking at FIG. 2 on the left there is a mold part 26 of the mold, a plurality of mold parts 26 being necessary depending on the housing parts 22 to be formed for the insertion of the control valves. These mold parts 26 are made in the manner of a cylindrical slide core which is shown completely in FIG. 3 and otherwise in FIGS. 2 and 3 as a half section. The respective mold part 26 discharges with its free end on the end side into the vicinity and on its other end is guided in the manner of a slide plate 28 which enables relative motion transversely to the molding tool 19, and therefore, running transversely to the supply channel 24, in the extended, nonmolding position the respective slide core being disengaged from the guide gates 16 of the molding tool 18 and in the shaping position of use engaging them, which will be detailed below.

As is shown in FIGS. 3 and 4, the guide gates 16 of the molding tool 18 which are located next to one another have through openings which are used for passage of the molding tool 26 and, as shown especially in FIG. 4, which have a free cross section which is chosen to be larger than the free cross section of the installation space 20 to be molded. If for example the plastic material of the mold is supplied to the supply channel 24, it fills the space between the guide gates 16 and the space between the through openings 30 and the outer peripheral side of the mold part 26 in the form of the slide core, under the assumption that FIGS. 2 to 4 show the slide plate 28 is in the molding position of use. For the sake of better illustration, FIGS. 3 and 4 show only parts of the molding tool 18 with the mold part 26 as well as the slide plate 28 and not the plastic material which, supplied in this respect, fills the open spaces within the mold as shown in FIG. 2. In this regard the other mold gates 32 as shown in FIG. 3 in their intermediate intervals form the side walls 14 of the plastic part 10 at the same time and as soon as the plastic part 10 has been removed from the mold, the ejected mold gates 32 of the molding tool 18 can be equated to the fluid-carrying channels 12 of the indicated control valve housing part.

Because the mold part 26 in the form of the slide core with a radial distance engages the through openings 30 of the guide gates 16 of the molding tool 18, for example with a distance between 0.05 to 0.5 mm, the slide plate 28 can be easily moved in and out and collisions with the remaining molding tool 18 and its parts can be reliably avoided. In order to be able to ensure reliable positioning of the shaping parts to one another, it can moreover be provided that each mold part 26 on its free end is caught in the remaining tool (not shown) and thus is blocked in forward motion. When the plastic material for shaping the plastic part 10 has been added, it also accumulates within the through openings 30 between the respective guide gate 16 and the mold part 26 in the form of the slide core, this plastic intrusion not constituting a major barrier when the slide plate 28 is moved back, for which the mold parts 26 then disengage from the guide gates 16, and with the added plastic material between the guide gates 16 which in this respect also extend over the slide core 26 (compare FIG. 2), the respective mold part 26 is disengaged, the plastic part 10 can be removed from the mold, for example by moving the bottom part of the tool in the form of the tool 18 down, viewed in the direction of looking at FIG. 2. The remaining wall parts which are not shown in the through openings are then broken out from the molding tool 18 with its guide gates 16 in this way and the required wall parts for forming the respective housing part 22 for the control valve then remain as shown in FIG. 1. The dimensional accuracy of this production process is precise such that a control valve can be placed directly in the assignable housing part 22 of the control valve housing part. Optionally reworking is necessary within the framework of conventional injection molding or diecasting processes in which residual burrs in the mold are removed by means of cleaning using brushes or blowing out.

The mold part is especially a duroplastic, preferably in the form of phenolic resin, as has become known among others under the trademark names of “Bakelite” and “Vyncolite”. This phenolic resin can be processed in the conventional manner by means of an injection molding or diecasting process using the described molding tools. It is especially advantageous to provide the phenolic resin with fillers, for example in the form of mineral fibers, glass fibers or carbon fibers in order in this way to improve workability.

The resulting control valve housing for a vehicle transmission is very thermally stable and compressively strong and moreover structurally light. Furthermore, a very good filling of the phenolic resin for the plastic part 10 is achieved, which accommodates the desired high pressure stability. The solution as claimed in the invention need not be limited to the application in control valve housing parts for transmissions, but can be used especially wherever dimensionally accurate installation spaces are to be formed for installation parts in phenolic resin mold parts and penetrate the wall parts of plastic parts molded in one piece.

1. A process for producing a plastic part (10), especially in the form of a control valve housing part for a transmission in motor vehicles, with a plurality of fluid-carrying channels (12), which is bordered at least partially by side walls (14), of which some arranged next to one another border on an installation space (20) for holding at least one installation part which is prepared as part of the molding tool (18) by means of the mold part (26).

2. The process as claimed in claim 1, wherein the molding tool (18) is provided with guide gates (16) which at least partially border the side walls (14) of the installation space (20) and are placed in through openings (30) which are used for passage of the mold part (26), and which have a free cross section which is chosen to be larger than the free cross section of the installation space (20).

3. The process as claimed in claim 2, wherein when the mold part (26) is placed in the through openings (30) of the molding tool (18) the plastic material is supplied to the molding tool (18) and fills the space between the mold part (26) and the assignable through opening (30) with the formation of wall parts and wherein after removal of the mold part (26) and ejection of the plastic part (10) from the molding tool (18) the latter breaks out the wall parts with clearance of the installation space (20).

4. The process as claimed in claim 1, wherein the mold material for the plastic part (10) is a duroplastic, preferably phenolic resin which is added to the molding tool (18) by means of an injection or diecasting process.

5. The tool for executing the process as claimed in claim 1, wherein it has at least one closable molding tool (18) and a mold part (26) which executes relative motion independently of the molding tool (18) to the latter.

6. The tool as claimed in claim 5, wherein the mold part (26) consists of an essentially cylindrically made slide core which is arranged to be able to move transversely to the guide gates (16) of the molding tool (18).

7. The plastic part, produced according to a process of claim 1 and by means of a tool as claimed in claim 5, wherein it is used as a control valve housing part for a transmission in motor vehicles.

8. The plastic part as claimed in claim 7, wherein the control valve housing part has fluid-carrying channels (12) which are bordered at least partially by side walls, of which part borders on an installation space (20) for engagement of a control valve as the installation part which is used for fluid triggering within the channels (12).
